(19) United States
(12) Patent Application Publication
(10) Pub. No.: US 2013/0024399 A1
(43) Pub. Date: Jan. 24, 2013

(54) SYSTEM FOR DYNAMICALLY ALLOCATING NATURAL RESOURCES

(71) Applicants: Hayne E. Leland, Berkeley, CA (US); John W. O'Brien, Corona del Mar, CA (US)

(72) Inventors: Hayne E. Leland, Berkeley, CA (US); John W. O'Brien, Corona del Mar, CA (US)

(21) Appl. No.: 13/629,408

(22) Filed: Sep. 27, 2012

Related U.S. Application Data
(63) Continuation of application No. 12/879,927, filed on Sep. 10, 2010, now abandoned.
(60) Provisional application No. 61/241,775, filed on Sep. 11, 2009.

(51) Int. Cl. G06Q 40/06

(52) U.S. Cl. 705/36 R

(57) ABSTRACT

Systems and methods for creating a dynamic resource trust can receive and distribute physical quantities of a resource at a future date. These systems and methods can be implemented in a computer system that dynamically designs and/or values shares of the trust's resources. These systems and methods can permit potential users of resources to tailor the amounts of resources they obtain under different market conditions in the future, with potentially lower costs than costs associated with futures contracts.

### RELATED APPLICATIONS

This application is a continuation of U.S. application Ser. No. 12/879,927, filed on Sep. 10, 2010, which claims priority from U.S. Provisional Patent Application No. 61/241,775 filed Sep. 11, 2009, and entitled “Method and Process for Hedging the Delivery and Price Risks of Natural Resources, Metals, Commodities and Financial Instruments,” the disclosures of both of which are hereby incorporated by reference in their entirety.

### BACKGROUND

Individuals and businesses attempt to protect themselves against adverse changes in supply conditions in resources they use or to adjust their usage in response to prices at the time they need the resources. Currently-available approaches for protecting against adverse supply changes have achieved varying degrees of success.

### SUMMARY

In certain embodiments, a system for allocating resource rights includes a computer system having computer hardware that is programmed to implement a dynamic resource trust creation module. The dynamic resource trust creation module can at least partially generate a trust document specifying units to be issued to a resource provider in exchange for promised delivery of a resource. The trust document can specify rules for separating the units into subshares and for subsequently transforming the subshares into fractional units. Further, the system can include a unit allocation module that can enable dynamic repricing of the subshares by at least subdividing a unit into initial first and second complementary subshares at an initial separation price. The resource provider can transfer ownership in at least one of the initial first and second complementary subshares. The unit allocation module can further recombine the initial first and second complementary subshares into a second unit at a new separation price in response to a request from a subshare holder. In addition, the unit allocation module can re-separate the second unit into new first and second complementary subshares at the new separation price. This dynamic repricing can enable price protection for the subshare holder even when one or more of the initial subshares is out-of-the-money. Further, the system can include a termination module that can calculate the fractional units at termination of the dynamic resource trust by at least calculating a fraction of a unit for the new first complementary subshare based at least partly on a price of the resource and calculating a complementary fraction of a unit for the new second complementary subshare based on the unit fraction of the new first complementary subshare. Delivery of the resource can be provided pro rata based on the fractional units.

Various embodiments of a method of allocating resource rights can include, in a dynamic resource trust that issues units to a resource provider in exchange for promised delivery of a resource, subdividing one of the units into a first complementary subshare and a second complementary subshare at an initial separation price at a request of the resource provider. The method can further include receiving a request from a holder of one of the first and second complementary subshares to reissue new first and second complementary subshares at a new separation price. The method can further include recombining the first and second complementary subshares into a new unit in response to the request. In addition, the method can further include re-separating the new unit into the new first and second complementary subshares at the new separation price and determining a price associated with the resource. In some cases, the method can include calculating, with one or more processors, a fraction of a unit corresponding to the first complementary subshare based at least in part on the resource price and calculating, with the one or more processors, a complementary fraction of a unit corresponding to the second complementary subshare based on the fraction of the unit calculated for the first complementary subshare.

A computer-readable storage medium can also be provided that, in certain embodiments, includes computer-executable instructions for implementing a method of allocating resource rights. This method can include issuing units to a resource provider in exchange for promised delivery of a resource, subdividing at least some of the units into a plurality of complementary subshares at an initial separation price at a request of the resource provider, and receiving a request from a holder of one of the subshares to reissue new subshares at a new separation price. The method can also include recombining the subshares into a new unit in response to the request, re-separating the new unit into the new subshares at the new separation price, and determining a price associated with the resource. Moreover, the method can include calculating complementary fractional units for each of the new subshares based at least in part on the resource price. Delivery of the resource can be provided pro rata based on the complementary fractional units.

In yet other embodiments, a method of allocating resource rights includes, by a computer system having computer hardware, issuing units to a resource provider in exchange for promised delivery of a resource, subdividing at least some of the units into a plurality of complementary subshares according to one or more separation rules, subsequently recombining the subshares into a new unit in response to a request to recombine the subshares, and re-separating the new unit into the new subshares according to one or more new separation rules.

In certain embodiments, a method of allocating resource rights includes, by a computer system comprising computer hardware: issuing units to a resource provider in exchange for promised delivery of a resource, subdividing at least some of the units into a plurality of complementary subshares according to one or more separation rules, subsequently recombining the subshares into a new unit in response to a request to recombine the subshares, and re-separating the new unit into the new subshares according to one or more new separation rules.

For purposes of summarizing the disclosure, certain aspects, advantages and novel features of the inventions have been described herein. It is to be understood that not necessarily all such advantages can be achieved in accordance with any particular embodiment of the inventions disclosed herein. Thus, the inventions disclosed herein can be embodied or carried out in a manner that achieves or optimizes one advantage or group of advantages as taught herein without necessarily achieving other advantages as can be taught or suggested herein.

### BRIEF DESCRIPTION OF THE DRAWINGS

Throughout the drawings, reference numbers are re-used to indicate correspondence between referenced elements. The drawings are provided to illustrate embodiments of the inventions described herein and not to limit the scope thereof.

FIG. 1 illustrates an embodiment of a dynamic resource trust scenario.

FIG. 2 illustrates an embodiment of an asset allocation scenario with respect to the dynamic resource trust.

FIG. 3 illustrates an embodiment of a computing system for implementing features of the dynamic resource trust.

FIG. 4 illustrates an embodiment of a dynamic resource trust formation process that can be implemented by the computing system.

FIG. 5 illustrates an embodiment of a unit allocation process that can be implemented by the computing system.

FIG. 6 illustrates an embodiment of a trust termination process that can be implemented by the computing system.

FIGS. 7 and 8 illustrate example trust payout scenarios.

### DETAILED DESCRIPTION

### I. Introduction

This disclosure describes embodiments of systems and methods for creating a dynamic resource trust that can receive and distribute physical quantities of a resource at a future date. These systems and methods can be implemented in a computer system that dynamically designs and/or values shares of the trust's resources. Advantageously, in certain embodiments, these systems and methods permit potential users of resources to tailor the amounts of resources they obtain under different market conditions in the future, with potentially lower costs than costs associated with futures contracts.

As used herein, the term “trust,” in addition to having its ordinary meaning, can include arrangements that do not precisely conform to any legal definition of the term “trust.” For example, the dynamic resource trust may, but need not be, a property interest held by one entity (the trustee) at the request of another (the settlor) for the benefit of a third party (the beneficiary).

### II. Dynamic Resource Trust Overview

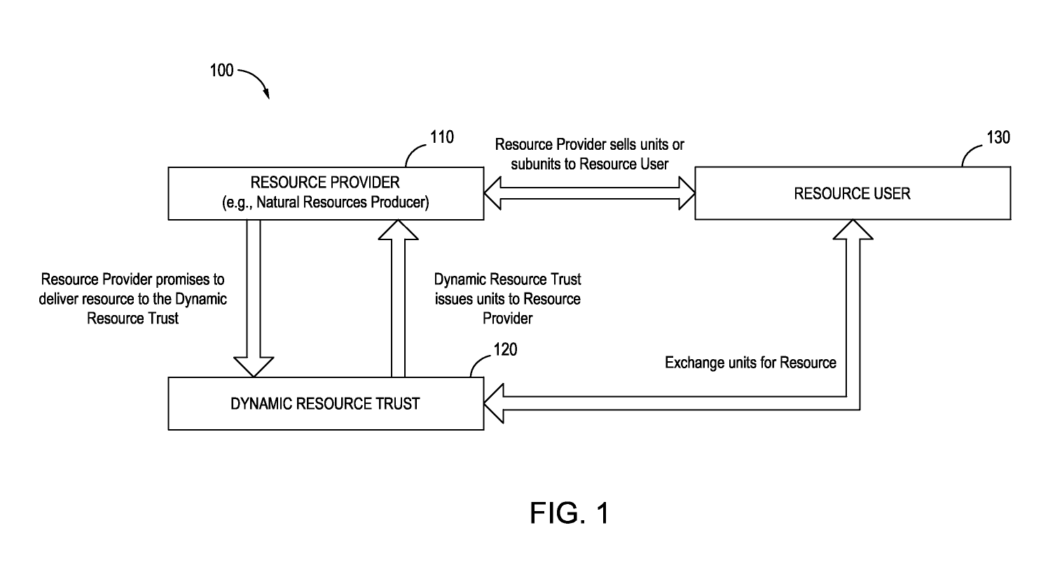

FIG. 1 illustrates an embodiment of a dynamic resource trust scenario 100. By way of overview, in the dynamic resource trust scenario 100, a resource provider 110 provides a promise to deliver a resource to a dynamic resource trust 120 or to the holders of securities of the trust 120. In exchange for this promise, the dynamic resource trust (“DRT”) 120 issues securities such as units to the resource provider 110. The resource provider 110, with the assistance of the trust 120, may subdivide the units and sell units or subunits to a resource user 130. At trust termination, the DRT 110 (or alternatively, the resource provider 110) delivers the resource to the resource user 130 based on the resource consumer's 130 outstanding units or subunits.

In various embodiments, the resource can be any natural resource, such as gas, oil, coal, or combinations of the same. The resource can also include commodities such as food items (such as corn or wheat), metals (e.g., gold, silver, etc.), or even financial instruments in some cases. The resource provider 110 can be any provider of such resources, including natural resource owners, producers, farmers, or the like. The resource user 130 can be any entity that consumes or uses resources. In the case of oil and gas resources, for example, the resource user 130 can be a utility, a refinery, a transportation company (e.g., airlines, railroads, trucking, shipping), the military, or the like.

In certain embodiments, the DRT 120 and related securities and techniques allow the resource users 130 to obtain future supplies of resources. For example, the DRT's 120 securities can provide for supplying quantities of a resource in the future that can depend upon one or more of: (i) the price of the resource at the termination of the DRT 120 or at a date close to termination, (ii) the average price of the resource over the life of the DRT 120, and (iii) the minimum price of the resource over the life of the DRT 120.

A resource user 130 that is a natural gas utility, for example, may want to lock in supplies that increase as the price of gas at termination (case (i)) is higher, so that less gas would need to be purchased on the spot market when gas is expensive. Alternatively, the utility might be more concerned with the average price of gas over the DRT 120 life than just the final price, in which case (ii) would be a more effective strategy. If the utility believes that gas prices can be volatile, it might prefer to lock in (for an initial cost) supplies at the minimum gas price over the life of the DRT 120 (case (iii)), limiting the advantage any rival might have that was clever (or lucky) enough to have bought at that price. The DRT 120 can design and create securities for any of these or other objectives. Computer-implemented processes for designing the securities and/or estimating the securities' market value can also be provided.

Advantageously, in certain embodiments, the terms of the DRT's 120 securities can be altered through time in a straightforward manner. As will be described in greater detail below, the flexibility accorded these securities can enable the resource provider 110 and resource user 130 to cost-effectively protect against changes in resource prices.

The DRT 120 can also allow resource providers 110, such as owners of natural resources (e.g., a national energy company) to transfer some or all of those resources to participants in the future, under flexible circumstances that are mutually beneficial to the providers 110 and users 130. Further, the DRT 120 can allow certain entities (not shown) whose economic success is highly dependent on the cost of certain resources (such as energy)—even though they may not directly produce or use significant amounts—to protect their fortunes. Examples of such entities can include companies in the automobile and tourism industries and solar-panel manufacturers.

In one embodiment, the DRT 120 is created by the resource provider 110, which may be a natural resource owner. The resource provider 110 can contribute a promise, for example, by providing a resource delivery contract that promises or guarantee to deliver a fixed quantity of the resource to the DRT 120 at a trust termination date (or set of dates), under specified conditions of delivery. In return, the resource provider 110 receives initial ownership of some or all securities in the DRT 120. The asset held by the DRT 120 can be this resource delivery contract (RDC), which can be converted into ownership of the resource by the DRT 120 or its security holders at, just before, or just after termination (or possibly at some other time). The RDC is one example of a trust formation document. However, a separate agreement from the RDC can be used to form the trust in some implementations.

The DRT 120 initially can issue units or other securities to the resource provider 110. In one example scenario, the DRT 120 issues one unit for each physical unit of the resource to be delivered under the RDC. The units can provide owners of the units (e.g., the resource users 130 and/or the resource provider 110) a pro-rata share of the DRT's 120 assets at termination. In one embodiment, no cash is exchanged by the DRT 120: the initial issuing of units to the resource provider 110 can be provided as consideration for the RDC. In one embodiment, the DRT 120 does not trade assets, nor does it receive or distribute cash during its life. Instead, administration fees for administering the trust 120 can be paid directly by the trust sponsor (the resource provider 110) to an administrator, without a need for cash to pass through the DRT 120. However, cash may pass through the trust in other implementations.

In one implementation, the DRT 120 enables the resource provider 110 to obtain units for a promise to deliver the resource, as described above, whereupon the resource provider 110 sells subunits to the resource user 130 to raise cash. At termination or just before termination of the trust 120, the resource provider 110 can repurchase the subunits from the resource users 130. The resource provider 110 can then return its units to the DRT 120 in exchange for a release of the provider's 110 guarantee to deliver the resource. In this scenario, the provider's 110 guarantee can collateralize the sale of subunits. If the provider 110 were not to repurchase and thereby redeem the subunits, the subunit holders could redeem the subunits by receiving delivery of the resource according to the provider's 110 guarantee with the trust 120.

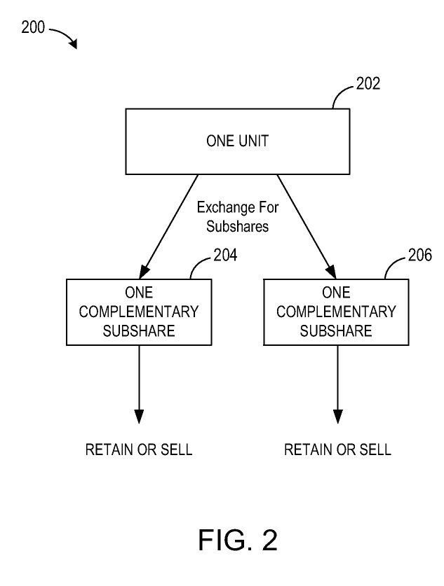

FIG. 2 illustrates an embodiment of an asset allocation scenario 200 with respect to the DRT 120. The asset allocation scenario 200 shown illustrates an example subdivision of a unit 202 into multiple subunits or subshares 204, 206. The divisibility of the units issued by the DRT 120 can beneficially enable flexible price and/or supply protection over the life of the DRT 120.

Upon submission to and approval by the DRT 120, any unit 202 may be separated into complementary subshares 204, 206. The holders of the complementary subshares 204, 206 may retain or sell these subshares 204, 206. The subshares 204, 206 are complementary, in certain embodiments, because participation rights of the subshares 204, 206 into which a unit 202 is split can collectively sum to the participation rights of one unit 202 at termination. As mentioned above, this participation right can represent the right to one physical unit of the resource. While many examples described herein involve a pair of subshares 204, 206, it may be desirable in some cases to split units 202 into more than two subshares 204, 206. Examples involving more than two subshares 204, 206 are described in greater detail below.

In the depicted embodiment, the unit 202 is split into a pair of subshares 204, 206 termed a first complementary subshare 204 and a second complementary subshare 206. The first of this pair, the first complementary subshare 204, can entitle the owner at termination to a fraction of a unit. This fraction of a unit can entitle the owner to ownership of a fraction of the resource that the unit receives at termination or an equivalent cash settlement. This fractional unit can depend upon the terminal market price or some other price of the resource, such as the average or minimum price of the resource over the life of the DRT 120. In one embodiment, rules defining payoffs can ensure or attempt to ensure that each subshare 204, 206 receives less than or equal to one unit of the DRT 120 at termination. Collectively, the subshares exchanged for a unit that is split can have claims totaling one unit of the resource at trust maturity or termination.

The specific amount of fractional unit ownership provided by each subshare at trust maturity can depend on a separation price parameter or some other parameter. The separation price can be established when the unit 202 is exchanged for the subshares 204, 206. This separation price can function like a strike price for the subshares 204, 206. More generally, any separation rule can be used to determine the amount of ownership provided by each subshare at trust maturity. Another example of a separation rule is a rule that allocates fractional units according to ranges that resource prices fall in (described in greater detail below) at the terminal date (or, in some embodiments, at arbitrary dates during the trust's life). For ease of illustration, the remainder of this specification will refer to separation prices, although it should be understood that any separation rule can be used to determine amounts of fractional units allocated to subshares.

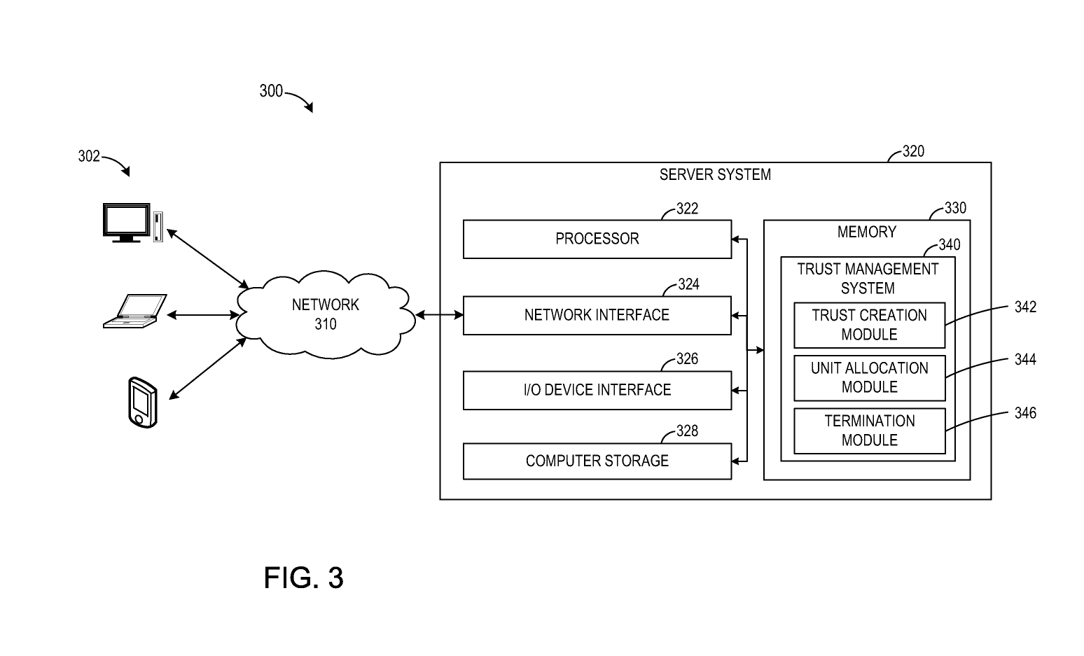

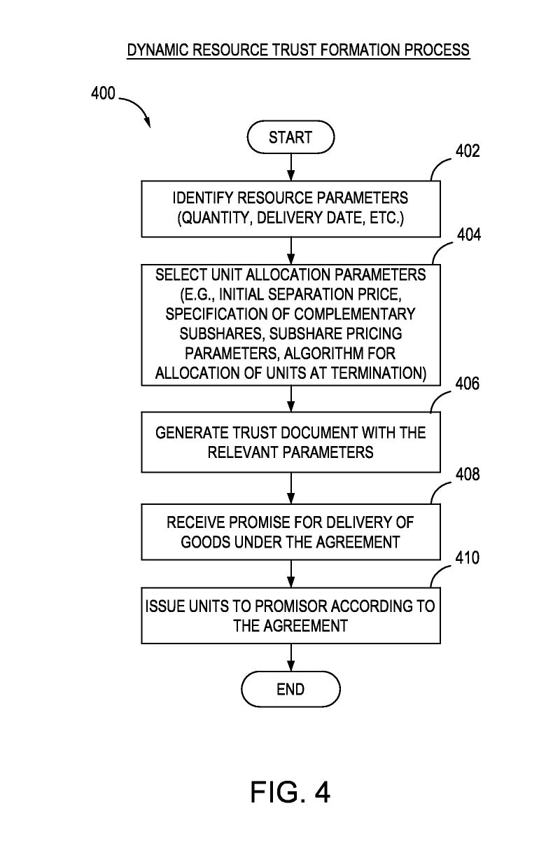

One algorithm for computing fractional units, which may be implemented by a computer system (see FIG. 3), is as follows: the first complementary subshare 204 at termination can receive one unit if the resource price at termination, p_{T}, is less than or equal to the separation price, and a fraction of a unit equal to (separation price÷p_{T}) if p_{T} exceeds the separation price. The second complementary subshare 206 can entitle the owner to a fraction of a unit equal to one minus the fraction granted to the first complementary subshare 204. Collectively, each pair of subshares 204, 206 can split the ownership of one unit 202 of the resource at termination, according to contractual terms specified in the trust formation document (see FIG. 4). For ease of illustration, the remainder of this specification will refer primarily to the price at termination in examples involving fractional unit calculations. However, it should be understood that the price at termination can be substituted with any other measure of price, such as the average or minimum price mentioned above.

When separating units 202, the unit holder, upon approval of an administrator of the DRT 120, may specify the fractions of units to be received by the complementary subshares 204, 206 at termination, for example, by specifying the separation price. This feature allows the securities of the DRT 120 to be altered over the life of the DRT 120, allowing future resource ownership to be tailored to specific desire of the resource provider 110 and user 130. This flexibility can allow the subshares 204, 206 to continue to be market-relevant securities even when the price of the resource may have moved far from its initial price. Specific numerical examples of fractional unit 202 valuation based on different separation prices are described in detail below.

Sales of ownership of units 202 and subshares 204, 206 can occur bilaterally between third parties without any cash transactions within the DRT 120. However, at any time prior to termination, the administrator of the DRT 120 can permit any a pair of complementary subshares (e.g., subshares 204, 206 separated with the same separation price) to be combined and exchanged for a unit 202. These units 202 can then be re-separated at a different separation price with approval by the unit holder and the administrator of the DRT 120. Units 202 can be separated and recombined any number of times, or some set maximum number of times, which may be specified by the trust formation document (see FIG. 4). In certain embodiments, no cash passes through the DRT 120 when units 202 are separated or subshares 204, 206 are combined. However, holders of units 202 or subshare 204, 206 may pay administrative fees to the administrator of the DRT 120 for share separation or recombination. Prior to termination, in one embodiment, the fund does not exchange individual subshares 204, 206 for units 202, other than as part of a complementary pair 204, 206 being exchanged for one unit 202.

At termination of the DRT 120, subshares 204, 206 can receive fractions of a unit 202 as specified by formulas in the original trust formation document (see FIG. 4). After the subshares 204, 206 receive their unit allocations, which may be programmatically determined by a computer system (see, e.g., FIG. 3), units are held by trust participants. Also at termination, the DRT 120 can receive delivery of the physical resource as specified by the RDC(s). Each unit 202 can then receive its pro-rata share of the resource, and the DRT 120 is terminated. Alternatively, a pro-rata share of delivery rights is provided to fractional unit holders prior to termination, so that fractional unit holders receive delivery directly instead of through the DRT 120. In another embodiment, the fractional unit holders receive an equivalent cash settlement instead of resource delivery. No cash is received or distributed by the DRT 120 at any time in various implementations, including at termination.

### III. Example Computer Implementations of the DRT

Before providing additional details and examples regarding the features of the DRT 120, a computing system for implementing the DRT 120 will be described. FIG. 3 accordingly illustrates an example computing system 300 that can implement some or all of the features of the DRT 120 described herein.

The example computing system 300 shown includes a server system 320 that implements a trust management system 340. The trust management system 340 can include hardware and/or software for implementing some or all of the features of the DRT 120, including formation of a trust document, separation of units into subshares, calculation of fractional units and payoffs at termination, and calculation of prices for subshares and/or suggesting separation prices, among other features. Example features of the trust management system 340 are described in greater detail below with respect to FIGS. 4 through 8.

The trust management system 340 is depicted as implemented by a single computing device (server system 320), but this arrangement is merely an illustrative example. In other implementations, the trust management system 340 may be embodied in a plurality of server systems or other physical computing machines, each executing an instance of the trust management system 340. These server systems may be distributed geographically or may be co-located.

The trust management system 340 may provide a network application such as a web application for access by users via user systems 302. Users may include investors who wish to trade securities associated with the DRT 120, such as subshares or units. The user systems 302 can include various types of computing devices, such as, for example, desktop computers, laptop computers, workstations, web pads, wireless handheld devices such as phones and personal digital assistants (PDAs), set-top television boxes, media players, tablets, kiosks, game systems, and the like. The user systems 302 can further include various software applications for accessing the server system 320, such as browser software applications, stand-alone software applications, plug-ins, interfaces, combinations of the same, and the like. The user systems 302 may access the server system 320 over a network 310, which may include a local or wide area network (LAN or WAN), such as an organization's intranet, the Internet, combinations of the same, and the like.

The general architecture of the server system 320 includes an arrangement of computer hardware and software components that may be used to implement the trust management system 340. The example server system 320 includes a network interface 324, a processing unit 322, an input/output interface 326, and computer storage 328 (such as hard disk storage, a storage area network, network attached storage, or the like), each of which may communicate with one another by way of a communication bus. The network interface 324 may provide connectivity to the network 310 and/or other networks or computing systems. The processing unit 322 may receive information and instructions from other computing systems via the network 310. The processing unit 322 may also communicate to and from a memory 330 and further provide output information for an optional display (not shown) via the input/output device interface 326.

The memory 330 can contain computer program instructions that the processing unit 322 executes in order to operate the trust management system 340. The memory 330 can include RAM, ROM, volatile memory, and/or nonvolatile memory. As shown, the memory 330 may include the trust management system 340, which may be executed by the processing unit 322. The trust management system 340 can include various modules of functionality. Example modules shown in the depicted embodiment include a trust creation module 342, a unit allocation module 344, and a termination module 346. The functionality of these components will be described in detail below with respect to FIGS. 4 through 6.

FIG. 4 illustrates an embodiment of a trust formation process 400 that can be implemented by the trust management system 340. In particular, certain features shown can be implemented by the trust creation module 342 of the trust management system 340 (see FIG. 3). Advantageously, in certain embodiments, the trust formation process 400 establishes parameters for a DRT that enable flexible participation in the DRT.

At block 402, resource parameters are identified. These resource parameters can include parameters related to a quantity of a resource to be delivered, a date for the delivery date, other delivery conditions, parameters regarding the quality of the resource, and so forth. These parameters may be supplied to an administrator of the DRT, who inputs the parameters into the server system 320 using the trust creation module 342. The resource parameters can be negotiated between the resource provider 110 and an administrator of the DRT 120.

Unit allocation parameters are selected at block 404. Examples of unit allocation parameters include an initial separation price, a number of initial units to be issued, a specification of complementary subshares that units can be separated into (e.g., two, three, or more subshares), subshare pricing parameters, and an algorithm for allocation of units at termination (see, e.g., FIG. 2), among others. The unit allocation parameters can also be negotiated between the resource provider 110 and the administrator. For example, the resource provider 110 and the trust administrator may negotiate the number of initial units to be issued. However, in other embodiments, the administrator of the DRT 120 establishes some or all of the unit allocation parameters unilaterally, such as the algorithm for allocating units at termination.

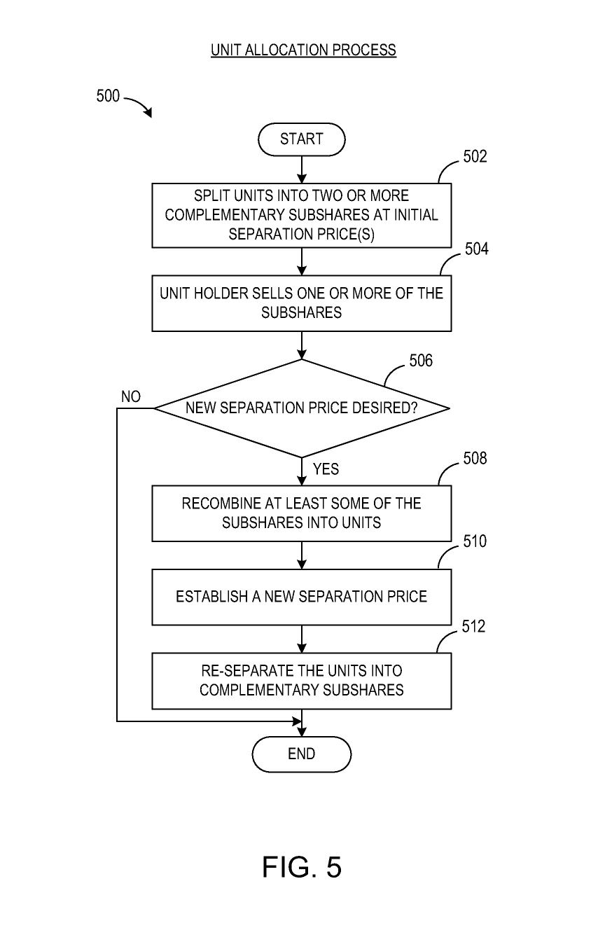

In one embodiment, the trust creation module 342 uses a mathematical model to establish prices for selling the subshares. These prices can also or alternatively be determined by the unit allocation module 344 at the time that units are separated into subshares (see FIG. 5). One example model that can be used or adapted for pricing the subshares is the Black-Scholes options pricing model. Other models, including variants of the Black-Scholes model, may be used.

The trust document is generated with the relevant parameters at block 406. The trust document may be generated programmatically by the trust creation module 342. Alternatively, the trust creation module 342 can programmatically select at least some of the resource and/or unit allocation parameters, and an administrator of the trust generates the trust document with these parameters. Upon execution of the trust document, the DRT 120 can receive a promise for delivery of goods under the trust document at block 408, and in return can issue units to the promisor (e.g., the resource provider 110) according to the trust document at block 410.

The DRT 120 can therefore provide a flexible form of transferring ownership of resources such as natural resources from a major owner (e.g., a national energy company) to resource users with differing supply requirements. The securities of the DRT 120 can be designed to meet specific resource parameters (e.g., supplies based on the excess of price over a given level, or average price). The DRT 120 structure can therefore provide for security specification, value estimation, and implementation to achieve specific user desires. These benefits can be accomplished through instruments collateralized by the resources themselves, through the trust formation document. Securities can be individualized (through the separation price or other parameters) for different users.

For the owners of the resource, the DRT 120 can provide two potential benefits: (i) as a method to reduce risks in the total value of its resources, and (ii) as a method for the raising of funds at low-risk rates. The economics of these transactions are illustrated in the Examples section below.

FIG. 5 illustrates an embodiment of a unit allocation process 500 that can be implemented by the trust management system 340. In particular, certain features shown can be implemented by the unit allocation module 344 of the trust management system 340 (see FIG. 3). The unit allocation process 500 describes techniques for dividing and recombining units according to the features described above with respect to FIG. 2.

At block 502, units are split into two or more complementary subshares based on an initial separation price or other parameter(s) that determine the fractional unit ownership of complementary subshares at trust maturity. This separation price can be negotiated in a side agreement between the unit holder (e.g., the resource provider 110) and potential buyers of one of the subshares (e.g., the resource user 130). The actual dividing of the subshares can be performed programmatically by the unit allocation module 344 upon permission of an administrator of the DRT 120. In one embodiment, the unit allocation module 344 can suggest a separation price at which to divide the units, using data regarding current resource prices, for example.

A unit holder sells one or more of the subshares at block 504. This sale can be conducted without the involvement of the administrator or the trust management system 340 in some cases. However, in other implementations, the sale can be brokered electronically through the trust management system 340. subshares can further be traded on an exchange or through the trust management system 340. In one embodiment, the trust management system 340 acts as, or is part of, an electronic exchange.

It is determined at block 506 whether a new separation price is desired. Either holder of a complementary set of subshares may request a new separation price and concomitant recombination of subshares into units. For instance, if the resource provider 110 holds a subshare, the resource provider 110 may wish to recombine the subshares at a more favorable separation price to match current market conditions. Similarly, resource users 130 or other holders of subshares (including possibly speculators) may wish to recombine subshares into units.

If no new separation price is desired, the process 500 ends. Otherwise, at least some of the subshares are recombined into units at block 508. subshares that were initially separated at the same separation price can be combined into units. The recombination of subshares can be performed electronically by the unit allocation module 344. A new separation price is established at block 510, either by the former subshare holders or by the trust management system 340. At block 512, the units are then re-separated into complementary subshares. The units can be re-separated programmatically.

Blocks 506 through 512 can be repeated any number of times during the life of the trust. Alternatively, the number of times that subshares can be recombined and split again can be limited by the trust formation document. In one embodiment, the number of subshares created with a new splitting of a unit can be variable. For example, an initial unit can be split into two subshares, then these subshares can be combined into a new unit, and the new unit can be split into more than two subshares. Many other configurations are possible.

At any time prior to termination, the DRT 120 as implemented by the trust management system 340 can separate any unit into subshares at a separation price determined by the owner and convert any pair of subshares with the same separation price back into a unit. Because no cash is involved with these internal transactions in some embodiments, possible taxable distributions by the DRT 120 prior to termination are reduced, and the likelihood that trust assets can be fraudulently diverted is reduced. The DRT 120 does not have an open-ended structure since, in certain embodiments, it may not offer to repurchase shares or units during its life.

Unlike unit investment trusts, mutual funds, or exchange-traded funds (ETFs), the ability of the DRT 120 to offer securities with tailored properties (e.g. the subshares with alternative separation prices) can bring unique advantages to both the resource owner and users. For example, the DRT 120 can avoid the fees, spreads, variation margins, and rolling costs incurred by the derivatives-based ETFs. The administration costs of the DRT 120 may also be low relative to 1940 Act funds, since in many implementations no trading of assets takes place in the DRT 120.

In contrast with multiple long-term sales contracts for individual buyers, the DRT 120 can therefore offer resource owners a single, low-cost vehicle to offer future supplies of the resource to multiple buyers under flexible terms. By selecting different separation prices, for example, individual tailoring of conditions to different buyers is possible. Advantageously, the DRT 120 therefore allows dynamic repricing of trust securities in certain embodiments without having to create a new trust or reform the current trust. Modifying the terms of resource supply through time is also possible through the recombination of subshares and subsequent separation at a different separation price.

Advantageously, in certain embodiments, the subshares provide some of the properties of derivatives' returns but have distinct differences. Because some or all of the DRT's 120 securities are collateralized by the resource provider's 110 trust formation document and underlying ownership of the resource, default risks to buyers are minimal. Variation margin is also not required from either the seller or buyers of DRT 120 securities in certain embodiments as there is no leverage in the DRT 120. Because of the absence of credit risk, and in further contrast with options and futures, longer-horizon securities can readily be offered. The rollovers typically required by futures contracts are unnecessary over the life of the DRT 120. And since large national energy companies can sponsor DRTs 120, sizable transactions are likely to be possible at low cost.

Subshares can also allow resource buyers to protect against resource price moves beyond a certain magnitude, without eliminating the possibility of gains from price moves in the opposite direction. First, consider protecting against rising oil prices with an ETF. If oil prices rise the buyer can profit, but can lose correspondingly if oil prices fall. On net, the buyer locks in a price and cannot benefit from falling prices (even as competitors may). In contrast, the owner of a second complementary subshare can obtain oil at a cost that is capped by the separation price. Losses if (say) oil price falls can be limited to any amount initially paid to the seller for the second complementary subshare. With the second complementary subshare, holders can protect against oil prices rising beyond a given amount, while still benefiting from price declines.

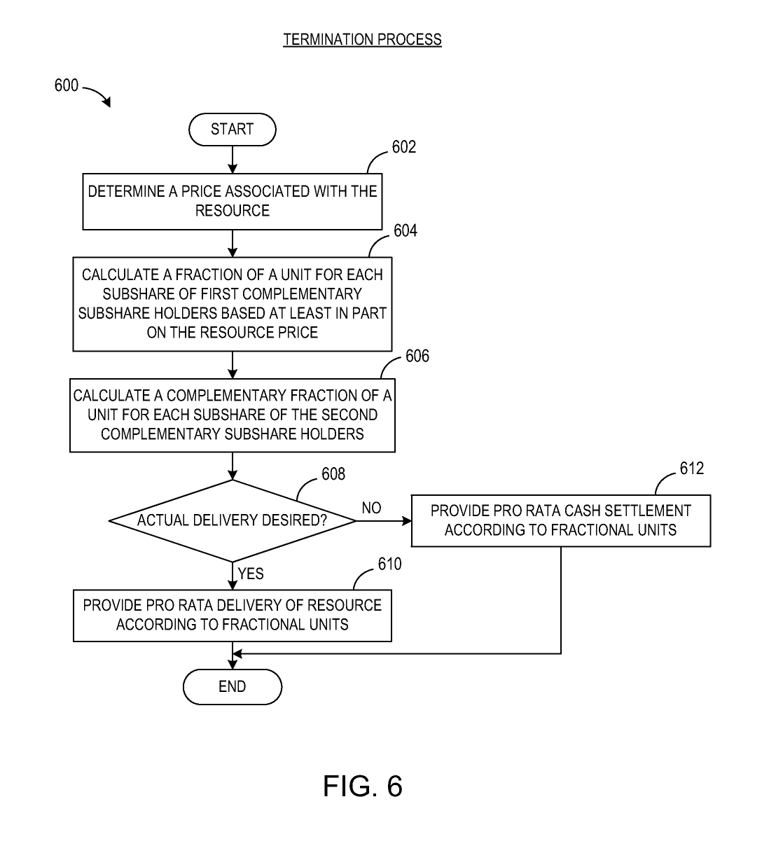

FIG. 6 illustrates an embodiment of a termination process 600 that can be implemented by the trust management system 340. In particular, certain features shown can be implemented by the termination module 346 of the trust management system 340 (see FIG. 3).

A price associated with a resource is determined at block 602. As described above, this price can be a current price, an average price, or a minimum price, among others. A fraction of a unit is calculated at block 604 for each subshare of the first complementary subshare holders based at least in part on the resource price. An example formula for calculating this fractional unit was provided above with respect to FIG. 2 (see also the Examples section below). Similarly, a complementary fraction of a unit for each subshare of the second complementary subshare holders is calculated at block 606. In certain embodiments, the trust management system 340 therefore transforms data representing a subshare into a fractional unit representing a physical amount of the resource.

If actual delivery of the resource is desired by the fractional unit holders, as determined at decision block 608, delivery of the resource is provided pro rata according to the fractional units at block 610. Thus, for example, a user holding 1.5 units at termination can receive 1.5 units of the resource, such as 1.5 barrels of oil, 1.5 ounces of gold, or the like. Otherwise, at block 612, a pro rata cash settlement is provided according to the fractional units owned. In certain embodiments, the cash settlement is performed between the resource provider and user, for example, with a separate agreement outside of the trust.

### IV. DRT Examples

Several DRT examples will now be provided. These examples use the algorithm for computing fractional units described above with respect to FIG. 2. As described above, in this algorithm, a first complementary subshare at termination can receive one unit if the resource price at termination, p_{T}, is less than or equal to the separation price, and a fraction of a unit equal to (separation price÷p_{T}) if p_{T} exceeds the separation price. A second complementary subshare can entitle the owner to a fraction of a unit equal to one minus the fraction granted to the first complementary subshare.

Common Assumptions for Examples 1 and 2:
(i) Natural gas is the resource
(ii) The resource provider 110, a national resources company, contributes a promise to deliver 1 billion mmBTUs (million British Thermal Units) in two years, at a particular delivery location (or locations). In exchange, the DRT 120 issues 1 billion units to the resource provider 110, each unit corresponding to delivery of 1 mmBTU of natural gas at the termination date. In these examples, no cash enters or exits the DRT 120 throughout the life of the DRT 120.
(iii) The price of natural gas at the initial date is $4.00/mmBTU

### Example 1

### Action

The resource provider 110 splits 1 billion units into pairs of a first complementary subshare and second complementary subshare with a separation price of A=$5.00/mmBTU. The resource provider 110 sells the second complementary subshares to users of the natural gas for $0.50 per subshare (which can be a price suggested by the computer model implemented by the trust management system 340), generating (outside the Trust) $500 million in revenues for the resource provider 110. The resource provider 110 retains the first complementary subshares. The DRT 120 keeps records of who owns units and subshares.

### Example 1

### Results

(i) If the Resource Price at the Termination Date is $6.00/mmBTU:

At termination, first complementary subshare owners can be entitled to receive N=$5.00/$6.00=0.833 units, which in turn can give them ownership of 0.833b mmBTU of gas. At $6.00/mmBTU, the 1 billion first complementary subshares retained by the resource provider 110 can be worth $5.00 billion.

The second complementary subshare owners can receive 1-0.833 units, or 0.167 units, which can give them ownership of 0.167 billion mmBTU (worth $1 billion) at an initial cost of $0.50×1 billion=$500 million. The net cost of the gas acquired by the complementary holders is $500 m/0.167b=$3.00/mmBTU, or half the open-market price of $6.00. If the second complementary subshare holders had purchased a number of subshares equal to their desired supply to natural gas users (in our example, purchasing 1 billion subshares to cover anticipated requirements of 1 billion mmBTU), the net cost of 0.167 billion @ $3.00 and the remaining 0.833 billion @ $6.00 (the market price) would be exactly the separation price plus the second complementary subshare cost, e.g. $5.50/mmBTU.

Indeed, for any market price at the termination date that exceeds $5.50, the second complementary subshare purchaser limits the cost of supply per mmBTU to $5.50. Thus, in this example, the DRT 120 offers an instrument to ensure the future supply of a resource at a bounded cost.

(ii) If the Resource Price at the Termination Date is $2.00/mmBTU:

At termination, the first complementary subshare owner can be entitled to 1.00 units; collectively the 1 billion subshares receive all 1 billion mmBTU of gas. In the example, the resource provider 110 would retain all the gas that it originally contributed, in addition to the $500 million of payments it initially received from the second complementary subshare purchaser. This would provide partial protection to the resource provider 110 against the fall in natural gas prices, and assure that the resource provider 110 would not be giving up natural gas when its price (and therefore revenue) is low.

The second complementary subshare owner may not receive any delivery of natural gas at this termination date price. On the other hand, the buyer could meet the desired supply to natural gas users at a total cost of 1 billion×$2.00/mmBTU, plus the “protection cost” of $500 million. The net cost of supply would be $2.50/mmBTU, which can be advantageous compared to locking in the current price of $5.00/mmBTU by a long-term contract, or using futures contracts. There is no requirement in these examples for a “variation margin” of $2.5 billion, which the futures contract would typically require prior to the termination date, nor is there the need to roll futures into the nearby contract in certain embodiments.

The first complementary subshare holder (here the resource provider 110) can receive all units in this example, and thus continues to own the resource. It delivers to itself, at zero (or at least minimal) cost. But the resource provider 110 did receive $500 million for selling its second complementary subshares. Thus, the resource provider 110 has protected itself against 20 percent of the $2.5 billion loss in value of its resources.

### Example 2

### Action

The resource provider 110 splits 1 billion units into pairs of first complementary and second complementary subshares with a separation price of B=$1.00/mmBTU. The resource provider 110 sells the 1 billion first complementary subshare to natural gas users or other investors. Since the price of natural gas is very likely to exceed $1.00/mmBTU, the value of gas received by a first complementary subshare at termination can be $1.00 with very high likelihood. The first complementary subshare should have the value of a low-risk 2-year discount bond, and, for example, can sell for $0.92 per share. The resource provider 110 receives $920 million in revenues (e.g., paid directly from the buyer of the first complementary subshares to the resource provider 110 outside the DRT 120). The resource provider 110 retains the second complementary subshares.

### Example 2

### Results

(i) If the Price at the Termination Date is $6.00/mmBTU:

The first complementary subshare owners can receive $1/$6×1 billion=0.167 billion mmBTU, with market value $1 billion at termination. Recalling the presumed purchase price of $920 million, this gives an annualized value return to the buyer of first complementary subshares equal to ($1.00b/$0.92b)^{1/2}−1=4.26%.

The second complementary subshare owners (here, the resource provider 110) can be worth $6 billion−$1 billion=$5 billion. In addition, the resource provider 110 raised $920 million at the initial date through sales of the first complementary subshare, at a cost that may well be lower than unsecured borrowing.

(ii) If the Price at the Termination Date is $2.00/mmBTU:

The first complementary subshare holder (purchased from the resource provider 110) receive 0.5 units (separation price÷p_{T}=$1/$2.00=0.50) worth $1.00 ($2.00×0.50). As when the price was $6.00, the first complementary owners receive a total of $1 billion. Thus the final value of these subshares is highly certain to be $1 billion in this example, which explains why (with the example's 2-year horizon) buyers of the first complementary subshares can be willing to pay $920 million at the initial date and receive a 4.26% annual return (which is still considerably higher than the current 2-year U.S. government interest rate). The second complementary subshare receives the remaining 0.5 units in this case, also worth $1 billion at termination.

### Example 3

Examples 3 and 4 illustrate embodiments of cash settlements instead of deliveries of a resource. In these examples, oil is the resource.

Scenario A:

The unit holder “A” specifies a separation value of $120/bbl. At expiration of the DRT 120, a first complementary subshare receives a fraction of a unit equal to 1 if the price of oil at expiration is less than $120/bbl. and a fraction of a unit equal to ($120÷price of oil) if the price of oil exceeds $120/bbl. The second complementary subshare receives a fraction of a unit equal to one minus the fraction received by the second complementary subshare. Thus, the second complementary subshare receives nothing if the price per barrel of oil at expiration is less than $120 and a fraction (1-$120/price) if the price exceeds $120.

Scenario B:

A unit holder “B” specifies a separation value of $140/bbl. At expiration of the DRT 120, the first complementary subshare receives a fraction of a unit equal to 1 if the price of oil at expiration is less than $140/bbl. and a fraction of a unit equal to ($140÷price of oil) if the price of oil exceeds $140/bbl. The second complementary subshare receives a fraction of a unit equal to one minus the fraction received by the second complementary subshare.

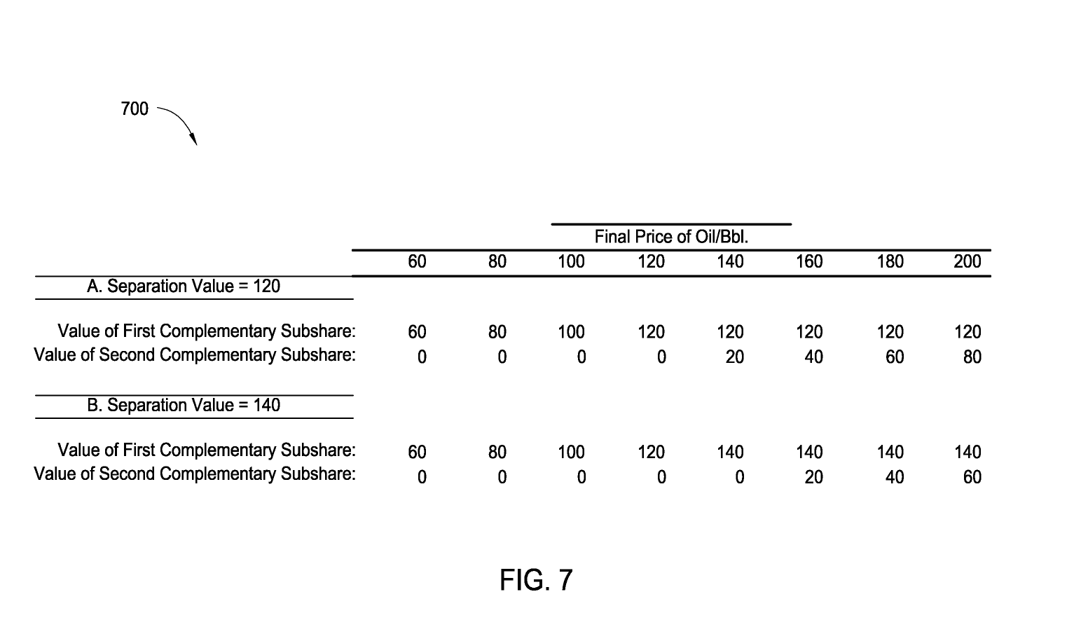

A table 700 shown in FIG. 7 illustrates the payoff for scenarios A (separation value of $120) and B (separation value of $140) for both subshares with various final oil prices. After unit separation, the investor in scenario A could sell his first complementary subshare and remain holding the second complementary subshare. As seen in the table 700, this investor would realize a profit whenever the price of oil exceeded $120 bbl., giving protection against costs of oil exceeding $120 bbl. An example of such an investor would be a resource user 130, such as an airline or public utility.

The investor in scenario B could sell his second complementary subshare. The buyer would have protection against the cost of oil exceeding $140 bbl. This investor would receive the full price per barrel of oil up to a maximum of $140. In addition, he would receive the revenue from selling the second complementary subshare, at least a partial hedge should the price of oil decline.

### Example 4

This example incorporates the sale of the second complementary subshare and its anticipated future value. In this example, a separation price of $50 is selected. The resource provider 110 initially sells second complementary subshares for a price of $15.82. This price may have been calculated by the trust management system 340 using a mathematical model, such as a Black-Scholes model. The projected future value at termination of the trust of this second complementary subshare is $16.45. The resource provider 110 therefore realizes $16.45 per barrel future value from its initial sale of second complementary subshares. In this example, the resource provider 110 retains the first complementary subshares.

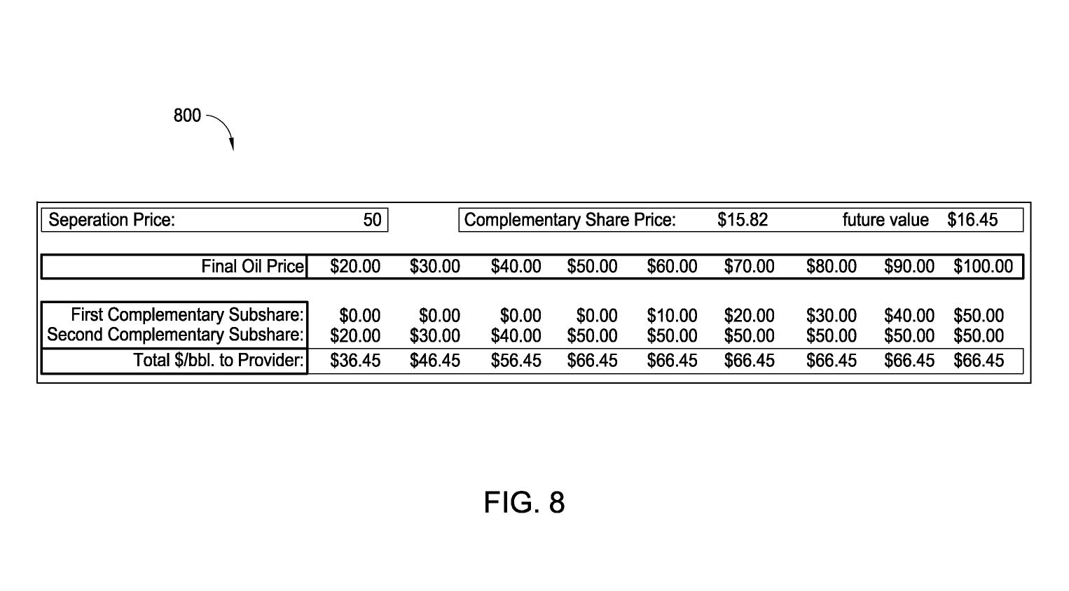

A table 800 shown in FIG. 8 illustrates payoffs for first complementary and second complementary subshares for various final oil prices with the separation value of $50. In this example, the profits from the sale of the second complementary subshares provide at least a partial hedge for the resource provider 110 against declining oil prices. For instance, if oil falls to $20/bbl., the effective price of oil received at termination by the resource provider 110 would be $36.45/bbl (see FIG. 8). In fact, the resource provider 110 would realize profits in this example whenever the final price of oil is less than $66.45/bbl. Further, the resource user 130 who purchases the second complementary subshare buys protection against the price of oil rising above $50/bbl.

### V. Other Embodiments of the DRT

The features of the DRT 120 and associated subshares can be customized and extended in many ways. Given a specification of desires for the structure of the trust, the mathematical payoff description of the requisite security(s) can be computed by the trust management system 340. The trust management system 340 can then generate parameters for a contract for the sale of subshares to deliver the desired payoff. The trust management system 340 can also apply advanced financial modeling to mathematically value alternative subshares. Any of the embodiments described in the following can be combined with any of the other embodiments described above.

Extension 1: Alternative Rules for Distribution of Units to Subshares at the Delivery Date(s):

Generally, any unit may be split into an arbitrary number of associated subshares i=1, . . . , L, where L is an arbitrary number. The DRT 120 trust document can specify a fractional number of units Nᵢ at the termination date(s) granted to subshare i of the unit by the formula

Nᵢ=fᵢ(p₀, p₁, . . . , p_{T}; K₁, . . . , K_{M}).

where p₀, . . . , p_{T} are the prices of the underlying instrument (or other reference instrument or index) at time periods 0 (initial period) to T (final period). Periods may be daily, monthly, yearly, or the like. K₁, . . . , K_{M} are parameters of arbitrary number M that serve to determine (along with the prices) the fractional splits to the subshares.

In one embodiment, restrictions include that 0≦Nᵢ≦1 for all i, and the fractions Nᵢ can sum to one (1) for any possible prices between 0 and termination T. As indicated previously, at any time a full set of subshares associated with a unit can be recombined by the trust into a unit (and subsequently resplit with different parameters, given approval of the unit owner and the trust).

As an example, each unit could be divided into two subshares i=1,2. The first subshare would at termination receive a fractional unit

N₁=(Min[p₀, p₁, . . . , p_{T}])/p_{T},

where “Min[x, y, . . . , z]” means “the least of x, y, . . . , z”. In this case, the other subshare would receive N₂ units at the delivery date, where

N₂=1−N₁=1−(Min[p₀, p₁, . . . , p_{T}])/p_{T}.

The value of the payoff at the delivery date to the second subshare is

p_{T}N₂=(p_{T}−Min(p₀, p₁, . . . , p_{T})),

which is also equivalent to the difference between the final price and the lowest price over the life of the DRT 120.

In certain embodiments, each unit has a series of complementary subshares m=1, . . . , M, and price levels K₁<K₂< . . . <K_{M+1}, where M>0 is an arbitrary integer, and complementary Share m receives Nₘ units at the terminal date, where

Nₘ=Min[Max(p_{T}−Kₘ,0),Kₘ₊₁−Kₘ]÷p_{T}

The single first complementary subshare receives 1−ΣₘNₘ. In this example, the complementary shares provide tranches of value as the termination price p_{T} increases. Further, in some embodiments, one of each type of the subshares can be recombined into a unit at any time prior to the delivery date, and can then be re-separated into subshares with different parameters Kₘ.

Extension 2: Price Ranges for Subshares:

As described above with respect to FIG. 2, separation rules other than separation prices can be established. For example, the subshares can be valued at termination according to price ranges. To illustrate, subshare A might have the right to 1 unit if p_{T}<$2.00, subshare B might have the right to 1 unit if $2.00 p_{T}<$6.00, and subshare C might have the right to 1 unit if and only if $6.00 p_{T}. Many types of price ranges can be constructed for different DRTs. Many other separation rules, criteria, or parameters can be established.

Extension 3: Delivery Dates:

The fund may hold a contract to deliver a given amount of the underlying asset at a sequence of future delivery dates. For example, the contract could include a promise to deliver X₁ mmBTUs of natural gas 3 months in the future, X₂ mmBTUs of natural gas in 6 months, etc. up to some maximal future delivery date (e.g. 60 months). In the above case, a unit (for example) could be specified as a contract to receive a pro-rata number of mmBTUs of natural gas delivered at each future delivery date, or as a right to a fixed number of mmBTUs of natural gas delivered at a specific future delivery date, in which case there would be as many distinct units as there are delivery dates.

### VI. Terminology

Depending on the embodiment, certain acts, events, or functions of any of the algorithms described herein can be performed in a different sequence, can be added, merged, or left out all together (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A system for allocating resource rights, the system comprising:
a computer system comprising computer hardware, the computer system programmed to implement:
a dynamic resource trust creation module configured to at least partially generate a trust document specifying units to be issued to a resource provider in exchange for promised delivery of a resource, the trust document specifying rules for separating the units into subshares and for subsequently transforming the subshares into fractional units;
a unit allocation module configured to enable dynamic repricing of the subshares by at least:
subdividing a unit into initial first and second complementary subshares at an initial separation price, the resource provider transferring ownership in at least one of the initial first and second complementary subshares,
recombining the initial first and second complementary subshares into a second unit at a new separation price in response to a request from a subshare holder, and
re-separating the second unit into new first and second complementary subshares at the new separation price, said dynamic repricing enabling price protection for the subshare holder even when one or more of the initial subshares is out-of-the-money; and
a termination module configured to calculate the fractional units at termination of the dynamic resource trust by at least:
calculating a fraction of a unit for the new first complementary subshare based at least partly on a price of the resource, and
calculating a complementary fraction of a unit for the new second complementary subshare based on the unit fraction of the new first complementary subshare, wherein delivery of the resource is configured to be provided pro rata based on the fractional units.

2. The system of claim 1, wherein the termination module is further configured to calculate the fraction of the unit for the first complementary subshare by assigning one unit to the subshare if the associated price is less than or equal to the new separation price.

3. The system of claim 2, wherein the termination module is further configured to calculate the fraction of the unit for the first complementary subshare by dividing the new separation price by the associated price if the associated price exceeds the new separation price.

4. The system of claim 3, wherein the termination module is further configured to calculate the complementary fraction of the unit for the second complementary subshare as one minus the fraction of the unit for the first complementary subshare.

5. The system of claim 1, wherein the price associated with the resource is a current price of the resource.

6. The system of claim 1, wherein the price associated with the resource is an average price of the resource over a life of the dynamic resource trust.

7. The system of claim 1, wherein the price associated with the resource is a minimum price of the resource over a life of the dynamic resource trust.

8. A method of allocating resource rights, the method comprising:
in a dynamic resource trust that issues units to a resource provider in exchange for promised delivery of a resource:
subdividing one of the units into a first complementary subshare and a second complementary subshare at an initial separation price at a request of the resource provider;
receiving a request from a holder of one of the first and second complementary subshares to reissue new first and second complementary subshares at a new separation price;
recombining the first and second complementary subshares into a new unit in response to the request;
re-separating the new unit into the new first and second complementary subshares at the new separation price;
determining a price associated with the resource;
calculating, with one or more processors, a fraction of a unit corresponding to the first complementary subshare based at least in part on the resource price; and
calculating, with the one or more processors, a complementary fraction of a unit corresponding to the second complementary subshare based on the fraction of the unit calculated for the first complementary subshare.

9. The method of claim 8, wherein said calculating the fraction of the unit corresponding to the first complementary subshare comprises a) assigning one unit to the subshare if the associated price is less than or equal to the new separation price and b) dividing the new separation price by the associated price if the associated price exceeds the new separation price.

10. The method of claim 8, wherein the dynamic resource trust allows the resource provider to protect a future value of the resource while allowing a user of the resource to cap a future cost of the resource.

11. The method of claim 8, further comprising using a financial model to calculate a price of one or both of the new first and second complementary subshares.

12. The method of claim 8, further comprising using a financial model to suggest the new separation price.

13. The method of claim 8, wherein a value at termination of each second complementary subshare is the greater of zero and the price of the resource minus the new separation value.

14. The method of claim 8, wherein a value at termination of each first complementary subshare is the lesser of the price of the resource and the new separation value.

15. The method of claim 8, wherein said calculating the fraction and the complementary fraction transforms data representing one of the new subshares into a fractional amount of the resource.

16. The method of claim 8, wherein delivery of the resource is configured to be provided pro rata according to the calculated fraction and complementary fraction of the unit.

17. The method of claim 16, wherein said calculating the fraction and the complementary fraction and said delivery of the resource transform data representing one of the new subshares into a fractional amount of the resource.

18. The method of claim 8, wherein a cash settlement in lieu of delivery of the resource is configured to be provided pro rata according to the calculated fraction and complementary fraction of the unit.

19. A non-transitory computer-readable storage medium comprising computer-executable instructions for implementing a method of allocating resource rights, the method comprising:
issuing units to a resource provider in exchange for promised delivery of a resource;
subdividing at least some of the units into a plurality of complementary subshares at an initial separation price at a request of the resource provider;
receiving a request from a holder of one of the subshares to reissue new subshares at a new separation price;
recombining the subshares into a new unit in response to the request;
re-separating the new unit into the new subshares at the new separation price;
determining a price associated with the resource; and
calculating complementary fractional units for each of the new subshares based at least in part on the resource price, wherein delivery of the resource is configured to be provided pro rata based on the complementary fractional units.

20. The non-transitory computer-readable storage medium of claim 19, wherein the complementary fractional units are each less than one and wherein the complementary fractional units sum to one.
